(19) United States
(12) Patent Application Publication
(10) Pub. No.: US 2019/0120215 A1
(43) Pub. Date: Apr. 25, 2019

(54) VARIABLE CONTROLLED RECIPROCATION DEVICE FOR FLUIDS

(71) Applicant: TONAND INC., London (CA)

(72) Inventor: Antonio Cannata, London (CA)

(21) Appl. No.: 16/168,343

(22) Filed: Oct. 23, 2018

Related U.S. Application Data
(60) Provisional application No. 62/640,863, filed on Mar. 9, 2018.
(60) Provisional application No. 62/576,320, filed on Oct. 24, 2017.

(51) Int. Cl. F04B 1/14; F03C 1/34; F03C 1/06; F04B 1/12

(52) U.S. Cl. CPC F04B 1/14; F04B 1/128; F03C 1/0607; F03C 1/0615

(57) ABSTRACT

An axial reciprocation device having a main piston and an anchor piston coupled to one another via a swivel joint interconnecting 20 a pair of connecting rods, the main piston positioned in a main cylinder bore and the anchor piston positioned in an anchor piston bore of a housing, such that the main piston is configured for axial reciprocation in the main cylinder bore; wherein variable positioning of the anchor piston along the anchor piston bore results in variable displacement of the main piston of hydraulic fluid with respect to an inlet/outlet port of the housing.

### CROSS-REFERENCE TO RELATED APPLICATIONS

This application claims priority from U.S. Provisional Patent Application No. 62/576,320, filed on Oct. 24, 2017 and U.S. Provisional Patent Application No. 62/640,863, filed on Mar. 9, 2018. The entire contents of which are hereby incorporated by reference herein.

### SUMMARY

It is an object of the present invention to provide a device to obviate or mitigate at least one disadvantage of the art.

### BRIEF DESCRIPTION OF THE DRAWINGS

FIG. 1 shows a reciprocation device;

FIG. 2 is an embodiment of the device of FIG. 1;

FIG. 3 is a further embodiment of the device of FIG. 1;

FIG. 4a shows a perspective view of a cam assembly of the device of FIGS. 2 and 3;

FIG. 4b shows a front view of the cam assembly of FIG. 4a;

FIG. 5 shows an example operation of the device of FIG. 1;

FIG. 6 shows an alternative example operation of the device of FIG. 1;

FIG. 7 shows a still further alternative example operation of the device of FIG. 1;

FIG. 8 shows a still further alternative example operation of the device of FIG. 1;

FIG. 9 shows a section view of an interior of the device of FIGS. 2 and 3 for an example actuator of the device;

FIG. 10 shows an example hydraulic device application of the device of FIG. 1;

FIG. 11 shows a further embodiment to the reciprocation device of FIG. 3;

FIG. 12a is a front view of the reciprocation device of FIG. 11;

FIG. 12b is a side view of the reciprocation device of FIG. 12a;

FIG. 13 is a further view of the reciprocation device of FIG. 11;

FIG. 14 is a further embodiment of the reciprocation device of FIG. 13;

FIG. 15 is a further view of the reciprocation device of FIG. 11; and

FIG. 16 is a further embodiment of the reciprocation device of FIG. 15.

### DESCRIPTION

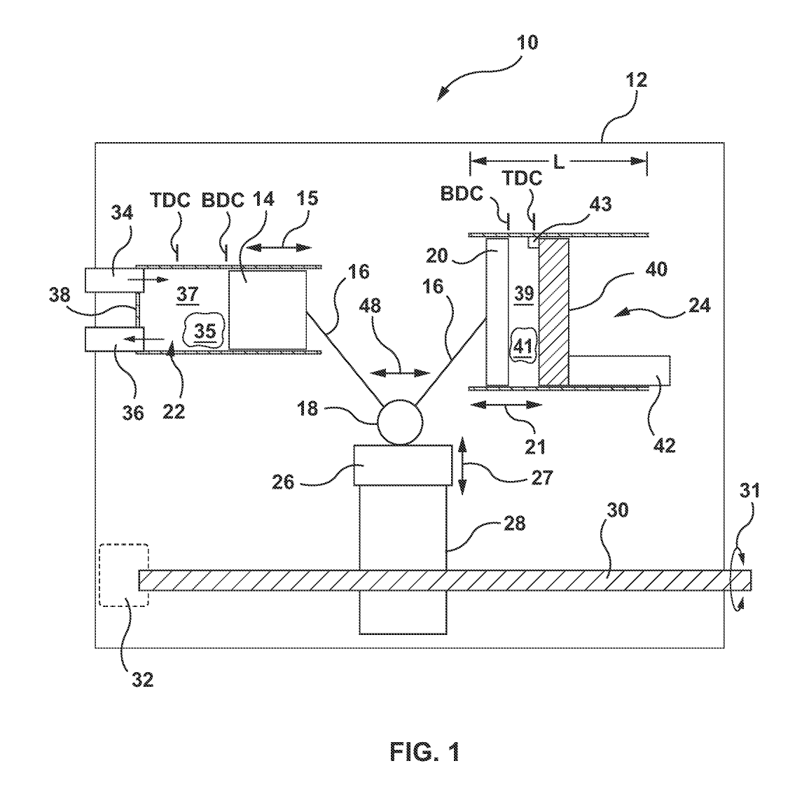

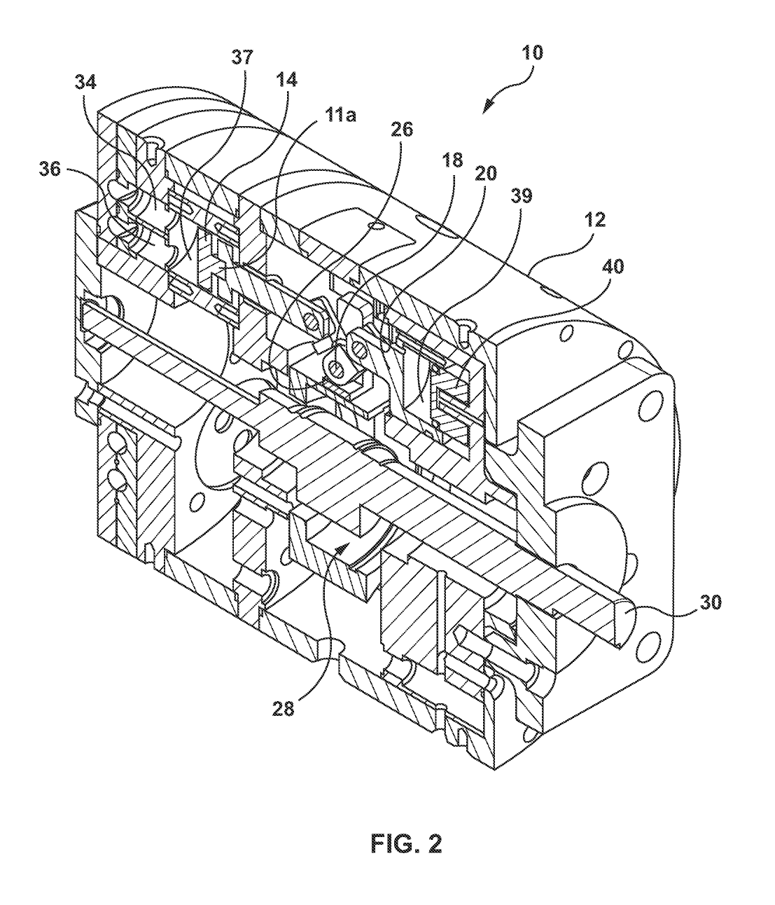

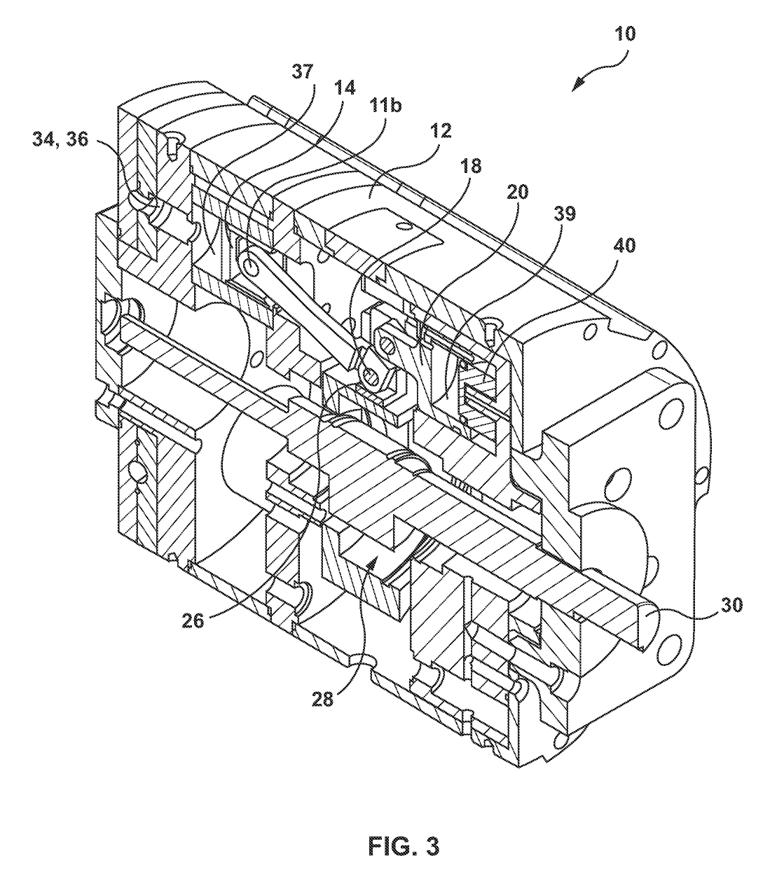

Referring to FIG. 1, shown is a device 10 comprising a housing 12 containing the components of a main piston 14, a pair of connecting rods 16 that are joined together by a swivel joint 18, and a passive piston 20 (also referred to as an anchor piston 20). The main piston 14 is configured to reciprocate 15 in cylinder bore 22 and/or the passive piston 20 is configured to reciprocate 21 in cylinder bore 24 during operation of the device 10. It is recognised that the cylinder bores 22,24 can be formed as part of the housing 12. One of the connecting rods 16 is coupled (e.g. as a fixed 11a or pivot 11b connection—see FIG. 2 for an example of the fixed connection 11a and FIG. 3 for an example of the pivot connection 11b) to the main piston 14 and the other connecting rod 16 is coupled to the passive piston 20, such that the swivel joint 18 is positioned on the connecting rods 16 between the pistons 14, 20.

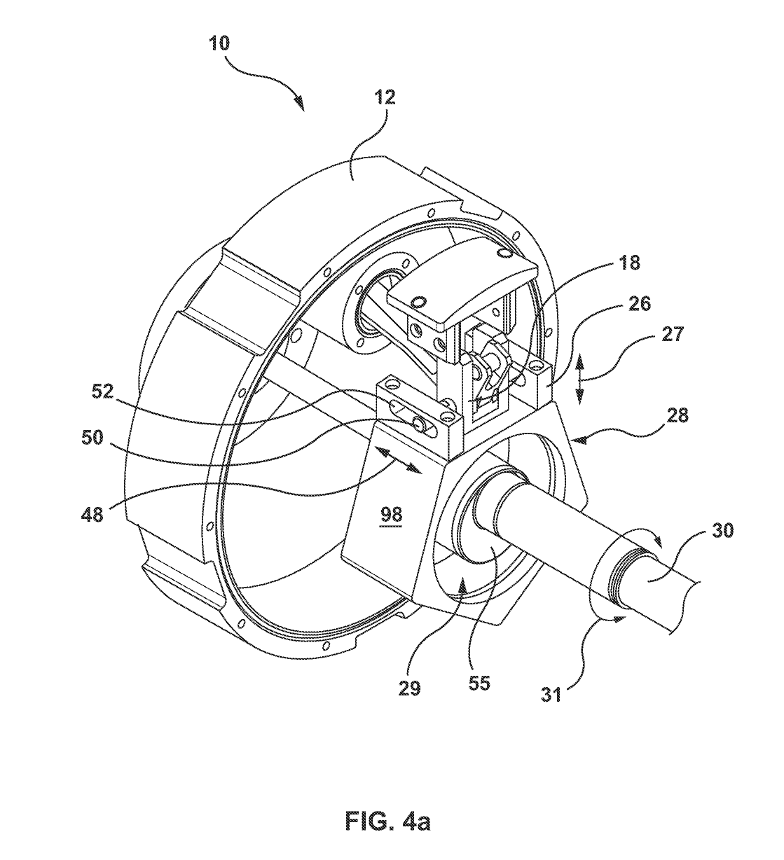

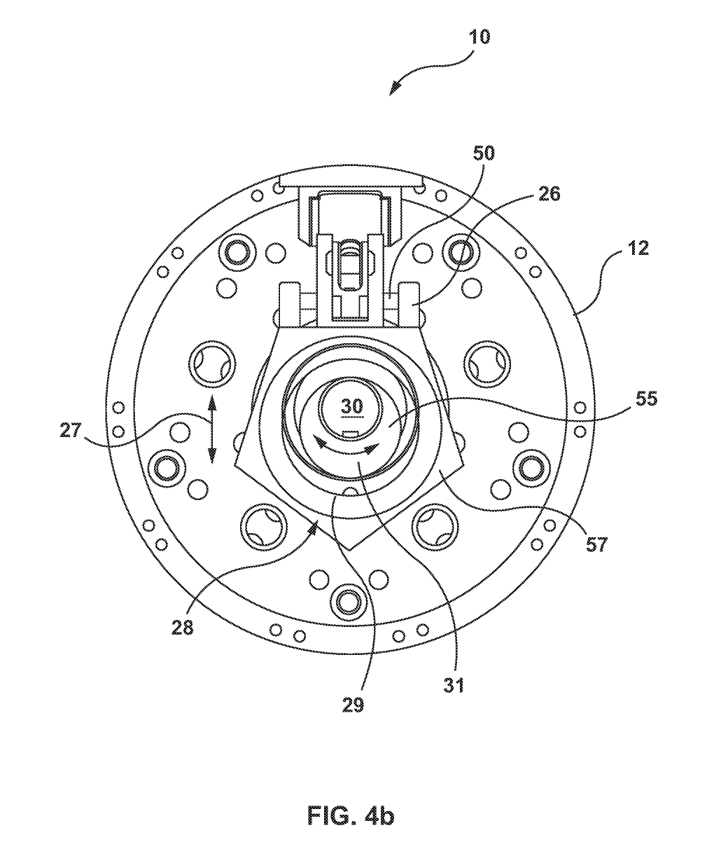

The swivel joint 18 is also coupled to a sled 26 (see FIG. 4a for an example connection) that reciprocates 27 due to the influence of an offset cam assembly 28 which rotates/oscillates via shaft 30 (i.e. a cam 55 is mounted on the shaft 30 in conjunction with a cam follower 29—see FIG. 4b).

Referring to FIGS. 4a, 4b, an example coupling of the swivel joint 18 to the sled 26 is via pin 50 and slot 52 arrangement. The slot is positioned in the body of the sled 26 and is arranged along the direction of reciprocation 48, thus guiding the motion of the swivel joint 18 laterally in relation to the reciprocation 27 of the sled 26, as the shaft 30 rotates. The offset cam assembly 28 includes the cam 55 mounted on the shaft 30 for conjoint rotation 31 therewith, which influences oscillation or gyration of the cam follower 29. The sled 26 is connected/mounted to one side of the cam follower 29, thus as the cam follower 29 oscillates/gyrates, the sled 26 reciprocates 27 as shown. As discussed above, as the sled 26 reciprocates 27 due to motion of the cam follower 29 the swivel joint 18 can reciprocate 48 in a lateral direction to the reciprocation 27, due to the difference if pressure or resistance encountered between the pistons 14,20 in their respective cylinder bores 22,24.

It is recognised that the shaft 30 can function as an input shaft in the event that rotation 31 of the shaft 30 is driven by a motor 32, such that rotation 31 of the shaft 30 causes concurrent rotation of the cam 55 in order to drive the sled 26 to reciprocate 27. Alternatively, the shaft 30 can function as an output shaft in the event that rotation 31 of the shaft 30 is driven by reciprocation 27 of the swivel joint 18, such that reciprocation(s) 15,21 of the pistons 14,20 cause(s) concurrent reciprocation 27 of the sled 26 (and corresponding rotation of the cam 55 adjacent thereto) in order to drive the shaft 30 to rotate 31. In terms of the passive piston 20 (e.g. the anchor piston 20), the extent of the travel 21, or not, dictates the magnitude of stroke (i.e. extents of the reciprocation 15) available to the main piston 14 as the device 10 operates (i.e. the shaft 30 rotates 31).

Referring again to FIG. 1, the cylinder bore 22 has one or more ports, such as an input port 34 and an output port 36. The input port 34 is configured to provide for the ingress of fluid 35 into a chamber 37 (of the cylinder bore 22) defined between the sidewalls of the cylinder bore 22, an end wall 38 and the opposing face of the main piston 14. The output port 36 is configured to provide for the egress of the fluid 35 out of chamber 37. It is recognised that opening and closing of the ports 34,36 can be actuated by any conventional means as desired, e.g. mechanical, electrical, etc, in order to affect the volume and hence pressure of the fluid 35 in the chamber 37.

It is recognised that the pressure of the fluid 35 in the chamber 37 can affect the reciprocation 15 of the main piston 14. For example, injection of fluid 35 into the chamber 37 can contribute to an increase in the pressure of the fluid 35 in the chamber 37 and thus cause the main piston 14 to reciprocate 15 in a direction away from the end wall 38. On the contrary, ejection of fluid 35 from the chamber 37 can contribute to a decrease in the pressure of the fluid 35 in the chamber 37 and thus facilitate the main piston 14 to reciprocate 15 in a direction towards the end wall 38, as further described below. It is also recognised that the pressure of the fluid 35 in the chamber 37 can provide a resistance to the reciprocation 15 of the main piston 14 from Bottom Dead Center (BDC) towards Top Dead Center (TDC). Similarly, the pressure of the fluid 35 in the chamber 37 can provide a push to the reciprocation 15 of the main piston 14 from Top Dead Center (TDC) towards Bottom Dead Center (BDC), as further described below.

Referring again to FIG. 1, the cylinder bore 24 has a chamber 39 defined between the sidewalls of the cylinder bore 24, an end wall or plate 40 and the opposing face of the passive piston 20. Resident in the chamber 39 is a resilient element 41 (e.g. mechanical spring, compressible fluid, etc.), such that reciprocation 21 of the passive piston 20 towards the end wall 40 is resisted/impeded by compression of the resilient element 41. On the contrary, reciprocation 21 of the passive piston 20 away from the end wall 40 can be assisted by expansion of the resilient element 41 (when previously compressed). It is recognized that one or more stops 43 can be positioned with respect to the end wall 40 and/or piston 20 in order to inhibit contact between the end wall 40 and the piston 20 during reciprocation of the piston 20. For example, the stop 43 could be positioned with respect to the cylinder 24 wall to make sure that the positioning of the end wall 40 (and thus the initial compression or precrush of the resilient element 41) does not interfere with the piston 20 travel as it reciprocates between the TDC and BDC in the cylinder bore 24. It is also recognized that the stop(s) 43 can also be configured with respect to the operation configuration of an actuator 42 (responsible for repositioning of the end wall 40), such that the actuator 42 would be inhibited from positioning the end wall 40 in a position that could potentially interfere with the reciprocation of the piston 20. It is recognized that the one or more stop(s) 43 could be positioned with respect to the piston 20 and/or end wall 40, such that a) the stop(s) 43 would be used to inhibit travel of the piston 20 from undesirable contact with the end wall 40, b) stop(s) 43 would be used to inhibit travel of the end wall 40 from being positioning in a position that could result in undesirable contact with the piston 20 during its reciprocation, and/or c) the stop(s) 43 would be used to inhibit travel of the piston 20 from undesirable contact with the end wall 40 as well as to inhibit travel of the end wall 40 from being positioning in a position that could result in undesirable contact with the piston 20 during its reciprocation.

In terms of the resilient element 41, in the case where the resilient element 41 is a spring or other mechanical resilient element, adjusting the positioning of the end wall 40 along a length L of the cylinder bore 24 provides for setting of the maximum and minimum resistances experienced by the passive piston 20 during the reciprocation 21. Positioning of the end wall 40 in a selected position along the length L can be accomplished via operation of an actuator 42 (e.g. a solenoid valve or other hydraulic means—see FIGS. 2 and 3). Alternatively, in the case where the resilient element 41 is compressible fluid, adjusting the positioning of the end wall 40 along a length L of the cylinder bore 24 can provide for setting of the maximum and minimum resistances experienced by the passive piston 20 during the reciprocation 21. Positioning of the end wall 40 in the selected position along the length L can be accomplished via operation of the actuator 42 (e.g. a solenoid valve or other hydraulic means—see FIGS. 2 and 3). Alternatively, or in addition to, the compression setting of the resilient element 41 (as compressible fluid) can be adjusted by introducing additional fluid into the cylinder bore 24 or removing fluid from the cylinder bore 24 via ports (not shown).

In terms of operation of the passive piston 20, when starting to travel from Bottom Dead Center (BDC) towards Top Dead Center (TDC), i.e. towards the end wall 40 and away from the main piston 14, the passive piston 20 would experience a minimum of resistance provided by the resilient element 41 to the reciprocation 21 in the direction towards the end wall 40. Further, when nearing Top Dead Center (TDC) and away from Bottom Dead Center (BDC), i.e. adjacent to the end wall 40, the passive piston 20 would experience a maximum of resistance provided by the resilient element 41 (due to compression of the resilient element 41 in the chamber 39 as the passive piston 20 has become closer to the end wall 40 and thus reduced the volume of the chamber 39) to the reciprocation 21 towards the end wall 40.

Alternatively, when starting to travel from Top Dead Center (TDC) towards Bottom Dead Center (TDC), i.e. towards the main piston 14 and away from the end wall 40, the passive piston 20 would experience a maximum of push provided by the resilient element 41 to the reciprocation 21 in the direction away from the end wall 40. Further, when nearing Bottom Dead Center (BDC) and away from Top Dead Center (TDC), i.e. furthest from the end wall 40, the passive piston 20 would experience a minimum of push provided by the resilient element 41 (due to decompression of the resilient element 41 in the chamber 39 as the passive piston 20 has become furthest from the end wall 40 and thus increased the volume of the chamber 39) to the reciprocation 21 towards the main piston 14.

As shown in FIG. 1, the position of the passive piston 20 in the cylinder bore 24 (i.e. instantaneous position along the reciprocation 15 path) can be influenced by the position of the swivel joint 18 along its reciprocation 27 path, while also being dependent upon a relative difference in resistance levels between the fluid 35 in the chamber 37 and the resilient element 41 in the chamber 39. Similarly, the position of the main piston 14 in the cylinder bore 22 (i.e. instantaneous position along the reciprocation 21 path) can be influenced by the position of the swivel joint 18 along its reciprocation 27 path, while also being dependent upon a relative difference in resistance levels between the fluid 35 in the chamber 37 and the resilient element 41 in the chamber 39. As such, the positioning of the pistons 14,20 in their cylinder bores 22,24 is dependent upon the relative resistances or “pressures” of the fluid 35 and the resilient element 41 acting on the respective faces of the pistons 14,20 as well as the position of the swivel joint 18 along its reciprocation path 27 (e.g. closer or further away from the shaft 30). It is the setting of position of the passive/anchor piston 20 in its cylinder bore 24, due to the setting of the pressure/force of the resilient element 41 on the passive/anchor piston 20 by positioning of the end wall 40 via the actuator 42, which can dictate the magnitude of stoke available to the main piston 14 for a given pressure of fluid 35 in chamber 37. As discussed, the positioning of the end wall 40 along length L dictates what the maximum force of the resilient element 41 will be when the passive piston 20 is at TDC and what the minimum force of the resilient element 41 will be when the passive piston 20 is at BDC. In the event that at any point in the travel 15 of the main piston 14 that the pressure of the fluid 35 in the chamber 37 is greater than the instantaneous pressure/force exerted by the resilient element 41 on the passive piston 20, the passive piston 20 will move 21 in the cylinder bore 24 accordingly.

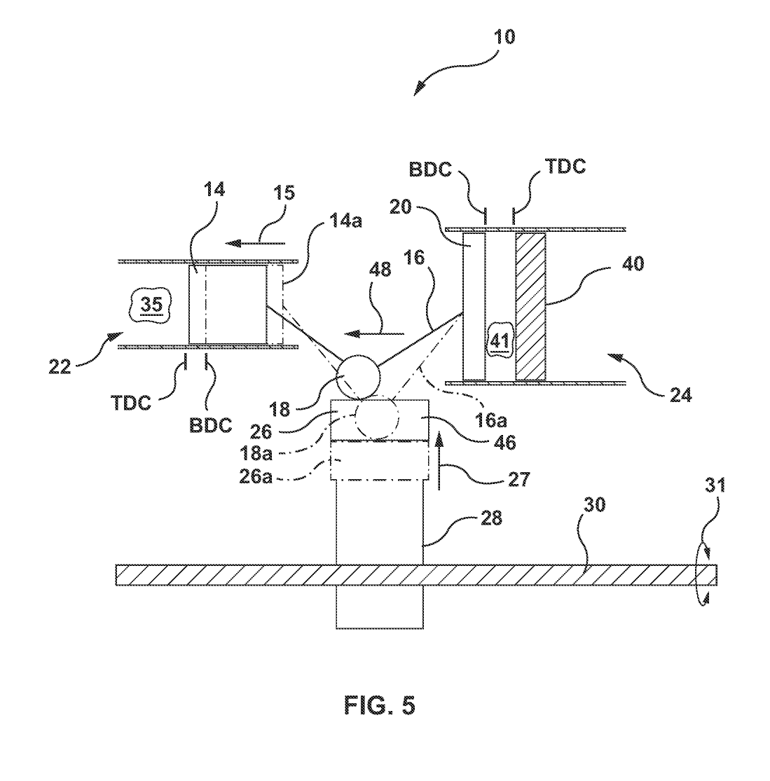

For example, referring to FIG. 5, shown is an end case where the fluid 35 pressure on piston 14 is less than that of the resilient element 41 pressure on piston 20, such that as the sled 26a (shown in ghosted view) moves to its new position as sled 26 (due to reciprocation 27 direction away from the shaft 30 under influence of the cam 55 rotation), the swivel joint 18a (shown in ghosted view) moves across a body 46 of the sled 26 in a direction 48 lateral to the reciprocation 27 direction and thus towards the cylinder bore 22 and away from the cylinder bore 24, in combination with travel in the reciprocation 27 direction. As such, the passive piston 20 can remain stationary in its piston bore 24 while the main piston 14a (shown in ghosted view) moves to its new position as main piston 14 in cylinder bore 22 (e.g. moves from BDC towards TDC). In this example, since the passive piston 20 remains stationary due to the difference in pressures of the fluid 35 and resilient element 41, the main piston 14 is directly coupled to the movement of the sled 26 via rotation of the cam 55.

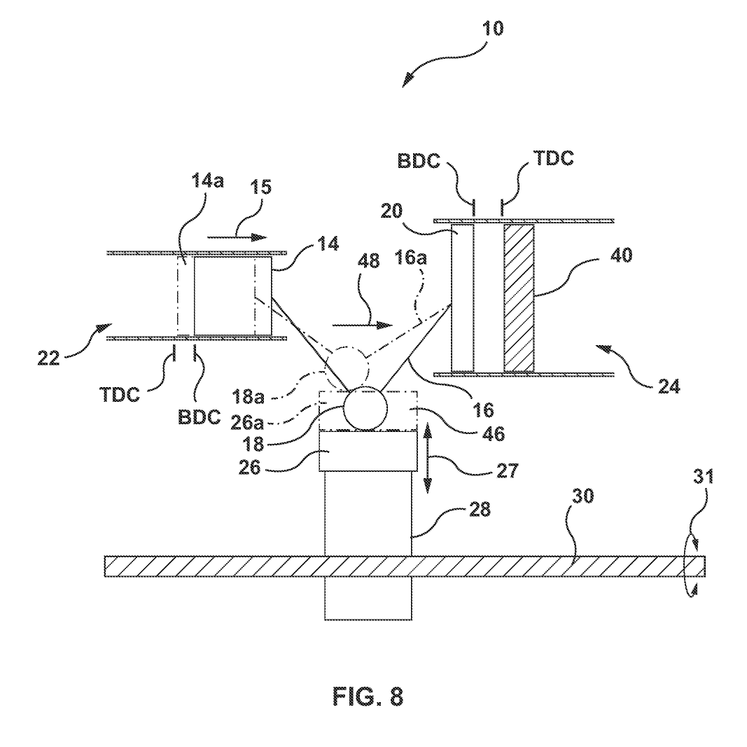

Referring to FIG. 8, shown is the opposite of the operation of FIG. 5, such that the swivel joint 18a returns to swivel joint 18 position as the cam 55 rotates, in the direction 48 lateral to the reciprocation 27 direction and towards the cylinder bore 24 and away from the cylinder bore 22, in combination with travel in the reciprocation 27 direction. In this case, the main piston 14a returns from TDC as piston 14 at BDC. FIGS. 5 and 8 show that the main piston 14 is directly coupled to the motion of the sled 26 via the cam 55 rotation, while the passive piston 20 is effectively decoupled.

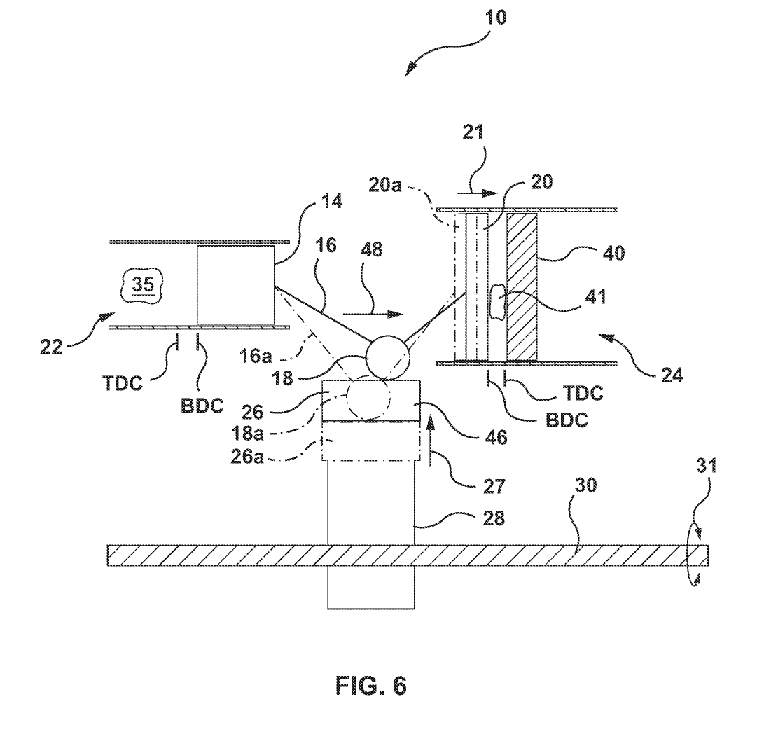

Referring to FIG. 6, shown is another end case where the fluid 35 pressure on piston 14 is greater than that of the resilient element 41 pressure on piston 20, such that as the sled 26a (shown in ghosted view) moves to its new position as sled 26 (due to reciprocation 27 direction away from the shaft 30 under influence of the cam 55 rotation), the swivel joint 18a (shown in ghosted view) moves across the body 46 of the sled 26 in a direction 48 lateral to the reciprocation 27 direction and thus towards the cylinder bore 24 and away from the cylinder bore 22, in combination with travel in the reciprocation 27 direction. As such, the main piston 14 can remain stationary in its piston bore 22 while the passive piston 20a (shown in ghosted view) moves to its new position as passive piston 20 in cylinder bore 24 (e.g. moves from BDC towards TDC). In this example, since the main piston 14 remains stationary due to the difference in pressures of the fluid 35 and resilient element 41, the main piston 14 is in effect decoupled from the movement of the sled 26 via rotation of the cam 55 (i.e. the cam 55 rotates but the main piston 14 remains stationary).

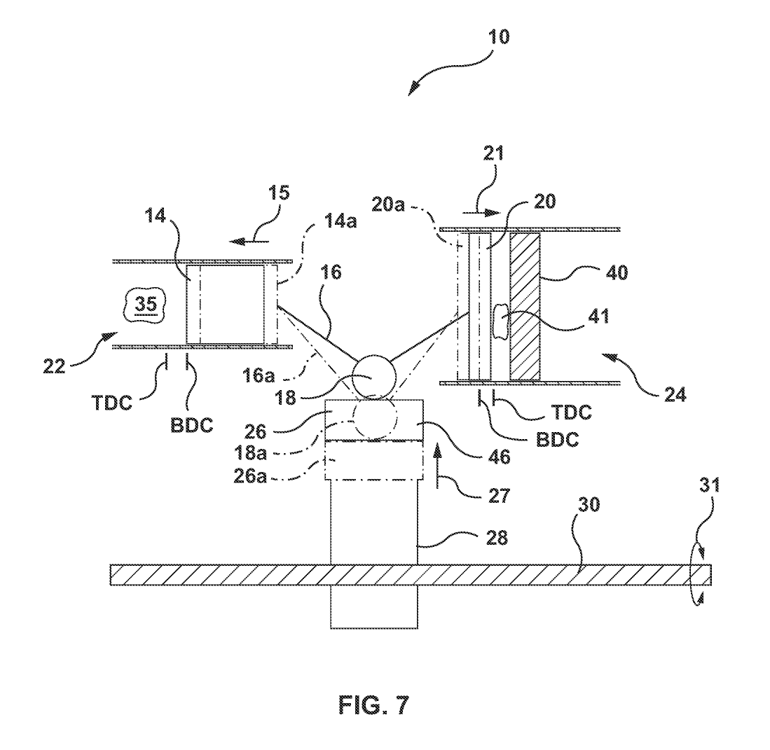

Referring to FIG. 7, shown is a middle case in which the pressure differential between the fluid 35 and the resilient element 41 is such that both the pistons 14a, 20a move to positions in their cylinder bores 22,24 as the swivel joint 18a moves in the direction 27 to swivel joint 18 position while travel in direction 48 (see FIGS. 5,6,8) is minimized. In this manner, operation of the pistons 14,20 are such that neither reaches their TDC when the cam 55 (via the cam follower 29) has pushed the sled 26a to sled 26 maximum position away from the shaft 30 (i.e. part of the maximum stroke of the main piston 14 is taken by movement of the passive piston 20 towards its TDC and part of the maximum stroke of the passive piston 20 is taken by movement of the main piston 14 towards its TDC). In this manner, both the pistons 14,20 are coupled to the movement of the sled 26 via rotation of the cam 55 (i.e. the cam 55 rotates as the pistons 14,20 move).

Comparing the operation of the device 10 using FIGS. 5,6,7, one can recognize that the ability of main piston 14 to travel completely between its TDC and BDC (i.e. to be able to reach its TDC due to full rotation of the cam 55) is dependent upon the movement (or lack thereof) of the passive piston 20. For example, the end case shown in FIG. 5 can be such that the end wall 40 has been positioned towards the cylinder bore 22 and thus the resultant increase in the resistance provided by resilient element 41 cannot be overcome by the pressure of the fluid 35 ingress and egress from the chamber 37. As such, the passive piston 20 can be configured by positioning of the end wall 40 to remain stationary while the cam 55 rotates and the main piston 14 reciprocates 15 in its cylinder bore 22. As discussed above, FIG. 6 is the opposite of FIG. 5, such that the main piston 14 is effectively decoupled from the rotation of the cam 55, for example by the end wall 40 has been positioned away the cylinder bore 22 and thus the resultant decrease in the resistance provided by resilient element 41 is decoupled from any ability for fluid 35 ingress and egress from the chamber 37.

The example shown in FIG. 7 is the middle ground between FIGS. 5 and 6, such that the end wall 40 has been positioned in an intermediate position in the cylinder bore 24 and thus the resultant resistance provided by resilient element 41 can be partially but not completely overcome by the pressure of the fluid 35 in the chamber 37 as the main piston 14 reciprocates 15. As such, it is clear in the operational example of FIG. 7 that part of the stroke of the main piston 14 (via the connecting rod 16 thereto) afforded by the rotation of the cam 55 is absorbed or otherwise eaten up by reciprocation 21 travel of the passive piston 20, seeing that the connecting rods 16 are of fixed length between the swivel joint 18 and the respective piston 14,20. In other words, part of the stroke of the main piston 14 is absorbed or otherwise stored via movement of the passive/anchor piston 20.

As such, in view of the above, the connecting rods 16 joined at the middle by the swivel joint 18 can operate in a “scissor” fashion (i.e. transitioning between a V and approaching straight line), such that the angle between the connecting rods 16 can change as the main piston 14 gets closer and further away from the passive piston 20 (in the case where the offset cam 55 is driven via the cam follower 29 by the main piston 14 or vice versa). It is clear that as the swivel joint 18 reciprocates 27 away from the shaft 30, the V shape of the connecting rods 16 flattens out (i.e. angle decreases) and the pistons 14,20 is/are move(d) away from one another (i.e. one or both reciprocate 15,21) in their respective bore(s) 22,24 towards their respective end wall(s) 38, 40. It is recognised that the ability of the main piston 14 to reciprocate 15, in view of rotation of the cam 55, is dependent upon the position setting of the end wall 40 along the length L of the cylinder bore 24 (or the initial set volume/pressure of the resilient element 41 in the chamber 39 if a compressible fluid).

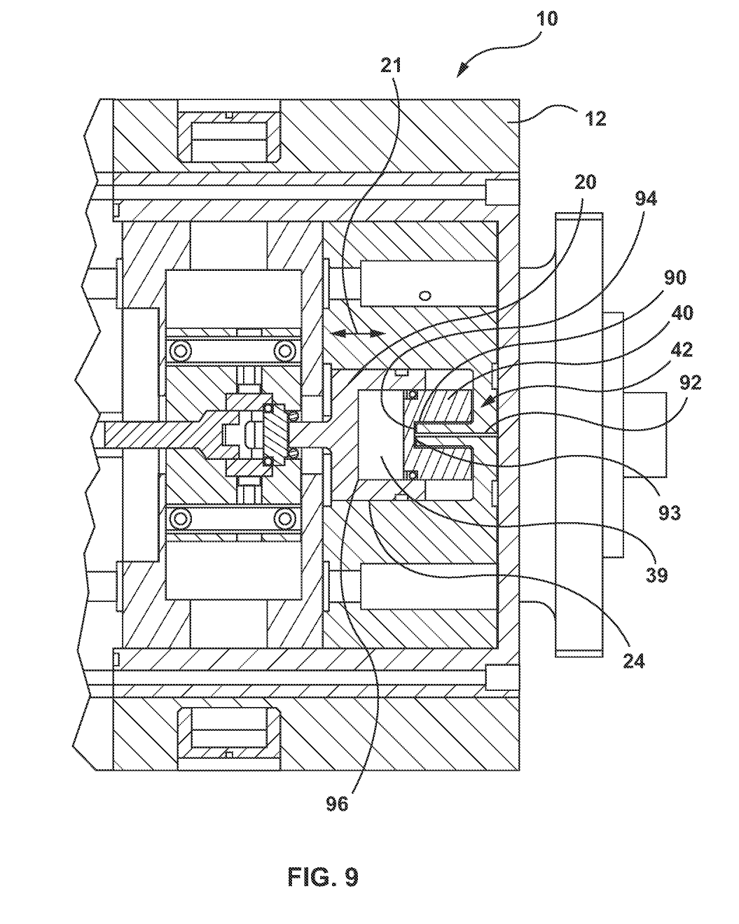

Referring to FIG. 9, the actuator 42 can be provided as a source of hydraulic fluid via line 92 to a chamber 90. The chamber 90 is situated between an inlet/outlet 93 of line 92 and an opposing face 94 of end wall 40 (e.g. a piston within a cylinder bore 96 positioned in passive piston 20. As such, in this example of FIG. 9, the passive piston 20 reciprocates 21 within the cylinder bore 24 and the end wall piston 40 can be variably positioned within the cylinder bore 96, thus affecting the available volume of the chamber 39 and resultant setting (e.g. maximum when passive piston 20 is at TDC and minimum when the passive piston 20 is at BDC) of the force/pressure of the resilient element 41 on the passive piston 20.

### Hydraulic Device Operation

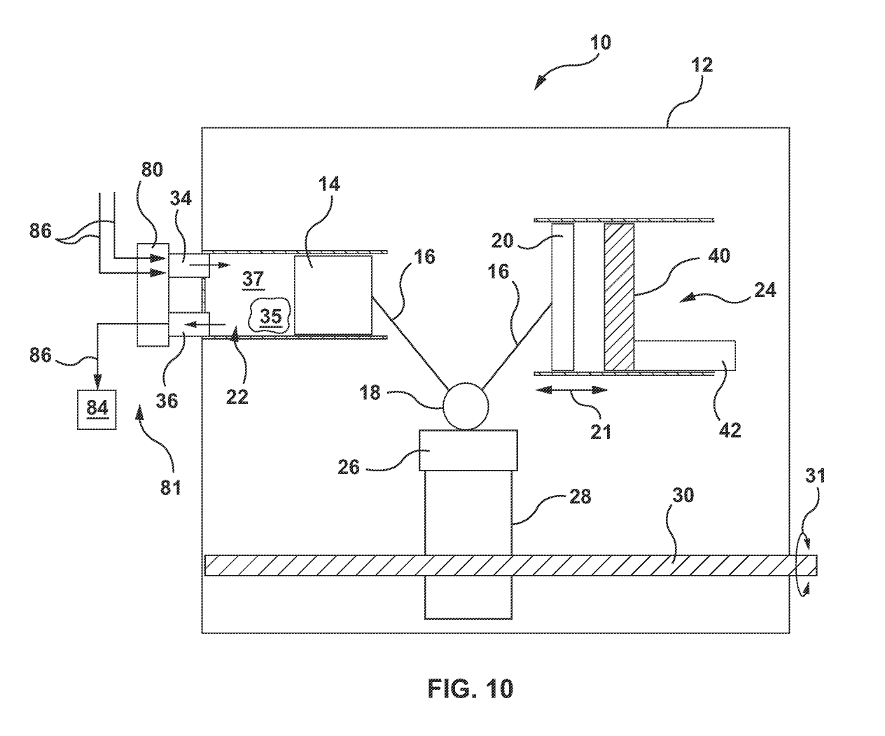

Referring to FIG. 10, shown is an example of the device 10 coupled to an hydraulic system 81, e.g. configured as an interconnected system of discrete components that transport liquid 35 between a fluid reservoir 80, the device as an hydraulic device 10 (e.g. hydraulic motor or pump) and a circuit device 84 (e.g. a hydraulically drive device such as a motor, a drill, etc.) via a series of fluid lines 86. The purpose of this system 81 can be to control where the fluid 35 flows (as in the network of tubes 86 of coolant in a thermodynamic system 81) or to control fluid pressure (as in hydraulic amplifiers 84). For example, hydraulic machinery uses hydraulic circuits 86 (in which hydraulic fluid 35 is pushed, under pressure, through hydraulic pumps 10,84, pipes 86, tubes 86, hoses 86, hydraulic motors 10,84, hydraulic cylinders 84, and so on) to move associated heavy loads.

Referring to FIGS. 1 and 10, describing the device 10 by example as a hydraulic pump 10, the port 36 is opened to control the egress of hydraulic fluid 35 from the chamber 37, with the port 34 remaining shut, thus emptying the chamber 37 as the main piston is driven from BDC towards TDC, i.e. reciprocation 15 in a direction away from the passive piston 20. It is also recognised that the two ports 34,36 can be combined as one input/output port.

Assuming the operational case where the passive piston 20 remains stationary in the cylinder bore 24 (i.e. force/pressure of the hydraulic fluid 35 in the chamber 37 cannot overcome the force of the resilient element 41 acting on the passive piston 20 in chamber 39), rotation 31 of the cam 55 (via the shaft 30) would cause movement 27 of the cam follower 29 in a direction away from the shaft 30, thus moving the attached sled 26 likewise. As movement 27 of the sled 26 occurs, swivel joint 18 would travel both in the direction 27 away from the shaft 30 as well as in the direction 48 (lateral to direction 27) away from the passive piston 20, as the main piston 14 is driven via the connecting rod 16 from BDC to TDC. The egress of the fluid 35 from the chamber 37 would travel along hydraulic lines 86 from the hydraulic pump 10, to the hydraulic load 84, and to the hydraulic reservoir 80. Similarly, in travel from TDC to BDC, the port 34 would be opened and the port 36 would be shut, thus providing for the chamber 37 to refill with fluid 35 as the main piston 14 travels 15 in the cylinder bore 20 under the influence of the connecting rod 16. It is recognised that on this return stroke, fluid 35 would be obtained from the reservoir 80 (and/or directly from the load 84) as the sled 26 and cam follower 29 travel back towards the shaft 30 as the cam 55 rotates. Similarly, the swivel joint 18 would move 48 in the return direction of back towards the passive piston 20 and also towards the shaft 30. In this manner the movement 15 of the main piston 14 and the movement of the cam 55 would be directly coupled to one another, while the lack of movement 21 of the passive piston 20 with the movement of the cam 55 would effectively decouple the passive piston 20 and the cam 55 from one another. This operational example can be defined as providing for a full/complete displacement of the fluid 35 volume from the chamber 37.

Further to the above, for an example of BDC to TDC travel of the passive piston 20, in the operational case where the main piston 14 remains stationary in the cylinder bore 22 (e.g. due to both ports 34,36 remaining closed—thereby providing for the force/pressure of the hydraulic fluid 35 in the chamber 37 being less that the force of the resilient element 41 acting on the passive piston 20 in chamber 39), rotation 31 of the cam 55 (via the shaft 30) would cause movement 27 of the cam follower 29 in a direction away from the shaft 30, thus moving the attached sled 26 likewise. To achieve a preferential difference in force/pressure between the fluid 35 and the resilient element 41, the end wall 40 could be actuated by actuator 42 to reduce the compression of the resilient element 41 in the chamber 39 by enlarging the chamber 39 volume.

Once the position of the end wall 40 is set along the length L, as the attached sled 26 moves 27 in the direction away from the shaft 30, the swivel joint 18 would travel both in the direction 27 away from the shaft 30 as well as in the direction 48 (lateral to direction 27) away from the main piston 14, as the passive piston 20 is driven via the connecting rod 16 from BDC to TDC. In this manner, the resilient element 41 would become further compressed in the chamber 39. It is recognised that on this BDC to TDC stroke, no fluid 35 would be obtained from the reservoir 80 (or ejected towards the load device 84) as the sled 26 and cam follower 29 travel away from the shaft 30 as the cam 55 rotates. It is recognized that this can be true for all pistons 14 on respective power stroke only, while some pistons are moving from BDC to TDC, others are doing the opposite. Similarly, the swivel joint 18 would move 48 in the return direction of back towards the main piston 14 and also towards the shaft 30, as the passive piston 20 returns from TDC to BDC while the resilient element 41 expands in chamber 39. It is recognised that this expansion can be used to help drive the passive piston 20 back towards BDC. It is also recognised that in the travel of the passive piston from TDC to BDC, both ports 34,36 remain closed. In this manner the movement 21 of the passive piston 20 and the movement of the cam 55 are directly coupled to one another, while the movement 15 of the main piston 14 and the movement of the cam 55 are effectively decoupled from one another. This operational example can be defined as providing for a zero displacement of the fluid 35 volume from the chamber 37 as a base case of variable displacement operation of the hydraulic pump 10.

In terms of the operational example of FIG. 7 described above, for the hydraulic device 10 of FIG. 9, a portion of the travel 15 of the main piston 14 is taken up or otherwise stored by the travel 21 of the passive piston 20, thus providing for a partial fill and partial empty of the chamber 37 of the fluid 35. As such, FIGS. 7 and 10 define a variable displacement operation of the hydraulic pump 10, such that the main piston 14 reciprocates 15 between its BDC and a position less than its stated TDC, due to simultaneous 21 travel of the passive piston 20 towards the end wall 40, thus effectively reducing the available volume of the chamber 37 for use in pumping the fluid to the hydraulic load 84 and to the hydraulic reservoir 80. This operational example can be defined as providing for a partial displacement of the fluid 35 volume from the chamber 37 as a case of variable displacement operation of the hydraulic pump 10 between full displacement and zero displacement examples described above.

In view of the above, it is recognised that magnitude of travel 48 of the swivel joint 18 depends upon the degree to which the pistons 14, 20 travel 15,21 at the same time, or not. For example, it is envisioned that the travel 48 can be provided as reciprocating away from and towards the passive piston 20, as reciprocating away from and towards the main piston 14, and/or can remain stationary (i.e. no travel/reciprocation 48 while travel 27 of the sled 26 occurs).

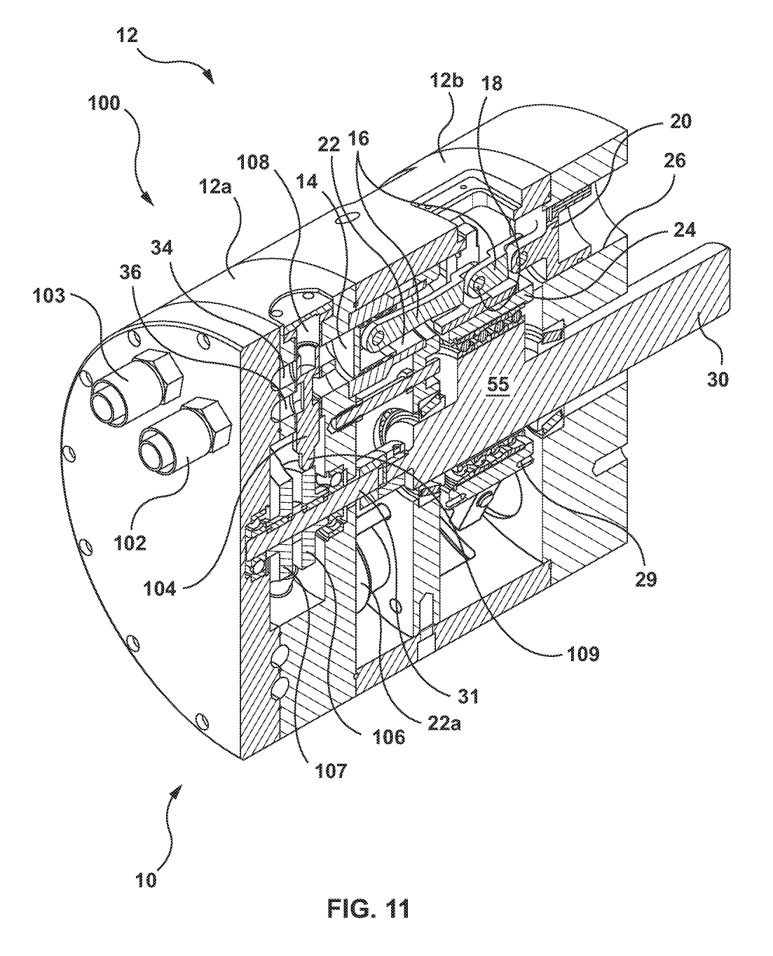

Referring to FIG. 11, shown is an alternative embodiment of the device 10 comprising the housing 12 containing the components of the main piston 14, the pair of connecting rods 16 that are joined together by the swivel joint 18, and the passive piston 20 (also referred to as the anchor piston 20). The main piston 14 is configured to reciprocate 15 in cylinder bore 22 and/or the passive piston 20 is configured to reciprocate 21 in cylinder bore 24 during operation of the device 10. It is recognized that the cylinder bores 22, 24 can be formed as part of the housing 12, namely housing portion 12b. One of the connecting rods 16 is coupled (e.g. as a fixed 11a or pivot 11b connection—see FIG. 2 for an example of the fixed connection 11a and FIG. 3 for an example of the pivot connection 11b) to the main piston 14 and the other connecting rod 16 is coupled to the passive piston 20, such that the swivel joint 18 is positioned on the connecting rods 16 between the pistons 14, 20. The swivel joint 18 is also coupled to the sled 26 that reciprocates due to the influence of the offset cam assembly which rotates/oscillates via shaft 30 (i.e. the cam 55 is mounted on the shaft 30 in conjunction with the cam follower 29).

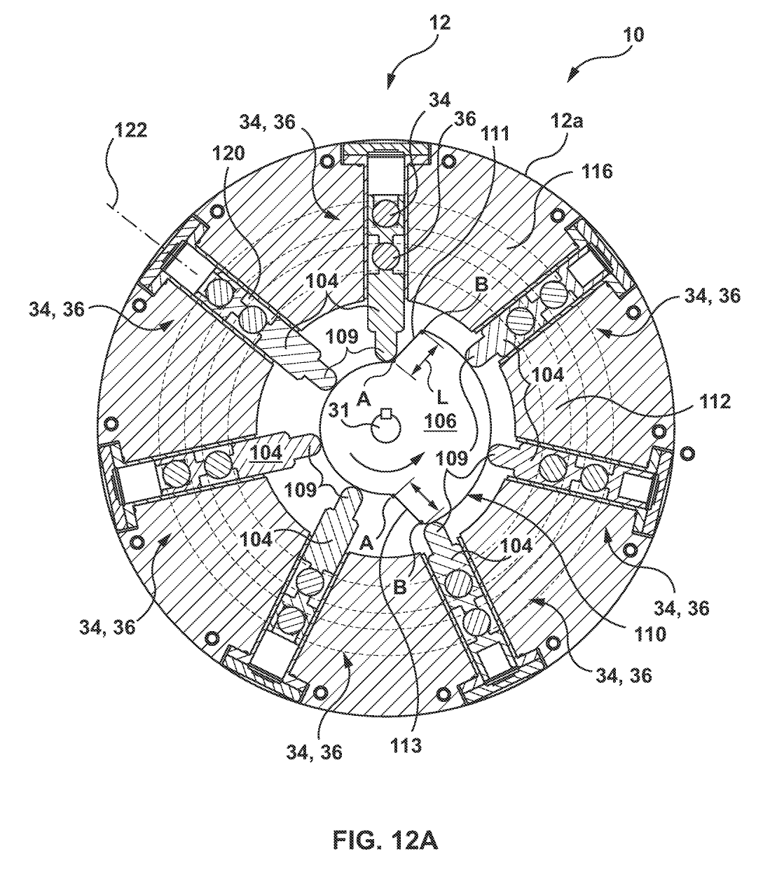

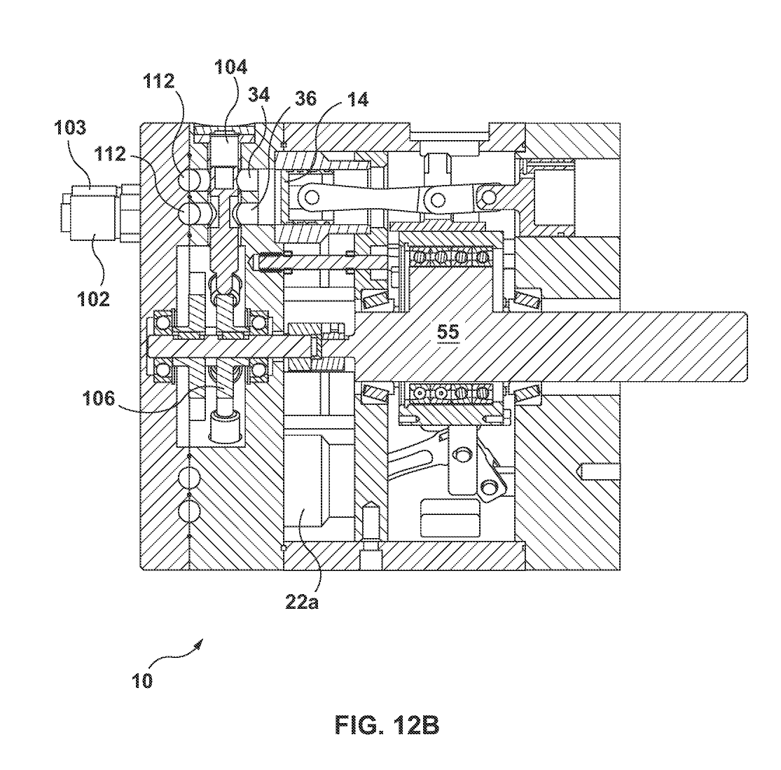

The housing 12 can also have housing portion 12a containing an inlet/outlet system 100 comprising an inlet port 102 and an outlet port 103 for both suppling hydraulic fluid 35 (see FIG. 1) as injection fluid to the cylinder bore 22 as well as receiving hydraulic fluid 35 as ejection fluid from the cylinder bore 22. The port 102 is fluidly coupled to the associated inlet ports 34 and the port 103 is fluidly coupled to the associated outlet ports 36 for each respective piston 14—piston 20 arrangement contained within the housing 12 as operated via the shared offset cam assembly 28 (see FIG. 2). Each pair of ports 34,36 is controlled via a respective shuttle valve 104, driven by cam 106 rotating on shaft 31. It is recognized that shaft 30 can be coupled to shaft 31 for conjoint rotation. In FIG. 11, the shuttle valve 104 is presently positioned in it's cylinder bore 108 as providing outlet port 36 open and in active fluid communication with the shared port 103 while providing inlet port 34 closed an therefore blocked from active fluid communication with the shared port 102. As shown by example in FIG. 11, the shuttle valve 104 is configured for reciprocation in the cylinder bore 108 between the states of open port 34—closed port 36 and closed port 34—open port 36, depending upon the positioning of the shuttle valve 104 in the cylinder bore 108 under influence of the cam 106, as followed by the cam follower 109. Further, the shaft 31 can have a cam weight 107 mounted thereon to provide for balancing due to the lobed cam surface 110 of the cam 106 (see FIG. 12a), which can introduce imbalance to rotation of the shaft 31.

Referring again to FIG. 12a, shown is an end view of the hydraulic device 10. Each inlet port 34 is coupled fluidly to each other inlet port 34 via a common inlet gallery 116. Similarly, outlet port 36 is coupled fluidly to each other outlet port 36 via a common outlet gallery 112, such that the port 102 is in fluid communication with the gallery 112 and the port 103 is in fluid communication with the gallery 116. Further, the cam surface 110, followed by each of the respective followers 109, has a first ramp 111 and a second ramp 113. such that for an example counterclockwise rotation of the cam 106 the first ramp 111 pushes the respective shuttle vales 104 as they encounter the first ramp 111 to shift from the outlet port 36 open state—inlet port 34 closed state to the inlet port 34 open state—outlet port 36 closed state. Similarly, the example counterclockwise rotation of the cam 106 is such that the second ramp 113 receives the respective shuttle vales 104 as they encounter the second ramp 113 to shift from the inlet port 34 open state—outlet port 36 closed state to the outlet port 36 open state—inlet port 34 closed state. The incline and decline lengths L (e.g. ramp lengths along the cam surface 110) of the first 111 and second 113 ramps are synchronized with the stroke duration of the main piston 14 (see FIG. 11), as the piston 14 travels from TDC to BDC or from BDC to TDC (see FIG. 1). In other words, as the follower 109 begins to climb the first ramp 111 (as the follower 109 travels from point A to point B—meaning the length L is from A to B or from B to A depending upon the ramp and travel direction in general), the associated main piston 14 is travelling from BDC towards TDC and thus exhausting the hydraulic fluid 35 from the cylinder bore 22 (see FIG. 1) out of the corresponding outlet port 36, into the common gallery 112 and out the port 102. The exhausting of the hydraulic fluid 35 from the cylinder bore 22 by the main piston 14 continues until the cam follower 109 reaches point B, at which time the main piston 14 reaches TDC and the outlet port 36 is closed and the inlet port 34 is opened via the shuttle valve 104. Similarly, as the follower 109 begins to descend the second ramp 113 (as the follower 109 travels from point B to point A), the associated main piston 14 is travelling from TDC towards BDC and thus receiving the hydraulic fluid 35 to the cylinder bore 22 (see FIG. 1) from the corresponding inlet port 36, as fed via the common gallery 110 and associated port 102. The receiving of the hydraulic fluid 35 to the cylinder bore 22 by the main piston 14 continues until the cam follower 109 reaches point A, at which time the main piston 14 reaches BDC and the inlet port 34 is closed and the outlet port 36 is opened via the shuttle valve 104. It is also recognized that the slot 120 of each shuttle valve 104 is sized lengthwise along a longitudinal axis 122 of the shuttle valve 140, such that the slot 102 length sizing inhibits both the inlet port 34 and the adjacent outlet port 36 from being open or close at the same time. This is provided by the spacing of the length sizing of the slot 120 along the longitudinal axis 122 being the same as or less than the spacing between edges of the inlet port 34 and the adjacent outlet port 36 along the longitudinal axis 122.

Referring to FIG. 12b, the hydraulic device 10 is shown in a cross sectional side view with galleries 116,112 coupled to port 102, such that the gallery 116 is coupled to inlet port 34 and the gallery 112 is coupled to the outlet port 36. In this figure, the operational state of the cam 106 and associated shuttle valve 104 is such that the outlet port 36 is open and the inlet port 34 is closed for the respective main piston 14. Also shown is the exterior wall 22a of the main piston (not shown) considered opposite to the main piston 14 depicted, which demonstrates the plurality of main pistons distributed about the housing 12 (see FIG. 12b), about the shafts 30,31, along with the corresponding distribution of respective shuttle valves 104.

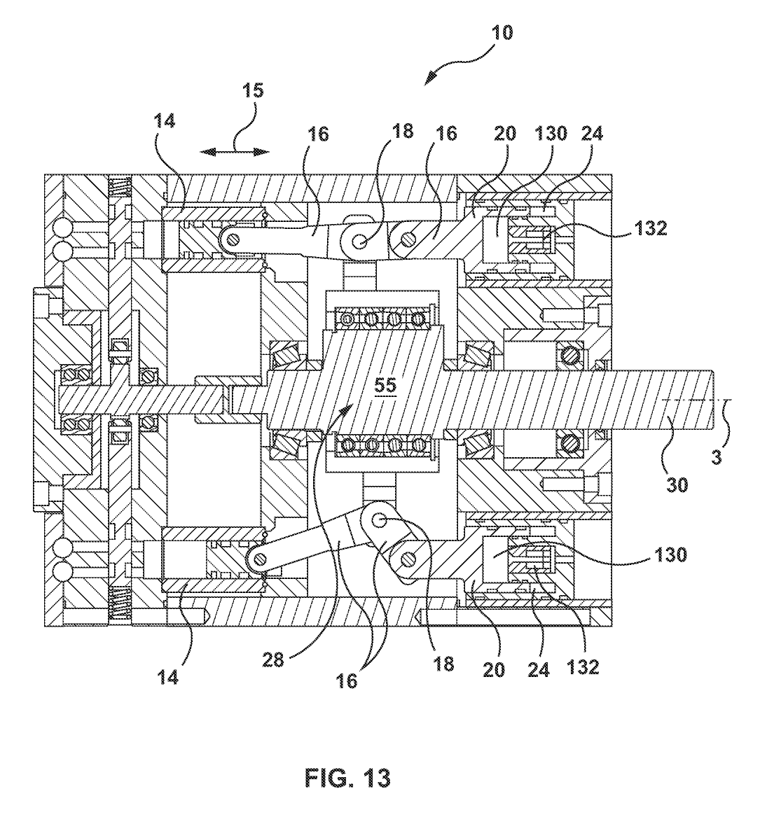

Referring to FIG. 13, shown is a cross sectional view of the hydraulic device 10 having each main piston 14 connected to a corresponding passive or anchor piston 20 via the pair of connecting rods coupled to the off-set cam assembly 28, via the swivel joint 18. As shown, the shaft 30 is oriented in line with the reciprocation 15 of the main pistons 14. In other words, an axis of rotation 3 of the shaft 30 (e.g. also of the cam 55) is aligned (e.g. parallel) with the axis of reciprocation 15 for the main pistons 14. Also provided by example, each of the anchor pistons 20 is coupled (e.g. pivotally) on one end to the connecting rod 16 and on the other end to a hydraulic chamber 130 containing an incompressible element (e.g. hydraulic fluid). Pressure/volume of the hydraulic fluid can be adjusted via addition or extraction of the hydraulic fluid from the chamber 130 via an injector 132. Accordingly, the position of the anchor piston 20 can be set via metering the amount of hydraulic fluid set in the chamber 130. As discussed above, positioning of the anchor piston 20 fully towards the end of the cylinder bore 24 nearest to the main piston 14 effectively lengthens the length of stroke available to the main piston 14 during the reciprocation 15. On the contrary, as discussed above, positioning of the anchor piston 20 fully towards the end of the cylinder bore 24 farthest from the main piston 14 effectively lengthens the length of stroke available to the main piston 14 during the reciprocation 15. The ability to lengthen or shorten the stroke length of the main piston 14 provides for variable displacement operation of the hydraulic device 10.

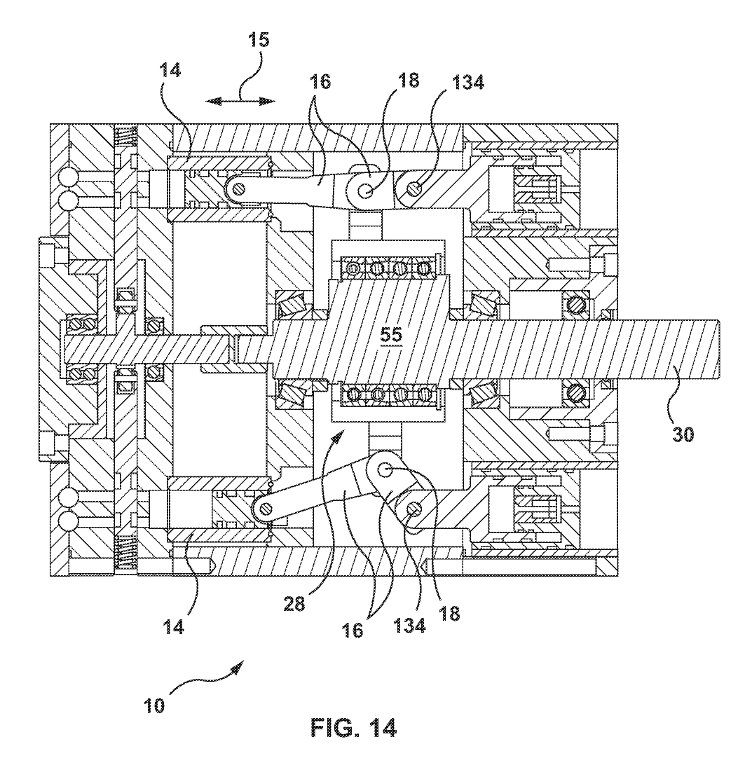

Referring to FIG. 14, shown is an embodiment of the hydraulic device 10 such that the cross sectional view depicts each main piston 14 connected to a corresponding fixed connection point 134 (e.g. pivot point) via the pair of connecting rods 16 coupled to the off-set cam assembly 28, via the swivel joint 18. As shown, the shaft 30 is oriented in line (e.g. parallel) with the reciprocation 15 of the main pistons 14. In other words, an axis of rotation 3 of the shaft 30 (e.g. also of the cam 55) is aligned (e.g. parallel) with the axis of reciprocation 15 for the main pistons 14. In this embodiment, the connecting rods 16 are only connected to a single piston 14, rather than a pair of pistons 14,20 as shown in FIG. 13. Accordingly, the single piston 14 (per pair of connecting rods 16) provides for the hydraulic device 10 configured as a fixed displacement axial pump/motor. In other words, the rotation of the off-set cam assembly 28 is directly converted to axial reciprocation 15 of the main piston(s) 14 and vice versa, such that the axial reciprocation 15 is directly coupled to the rotation of the cam 55. For example, each rotation of the cam 55 always results in the same stroke length (e.g. between TDC and BDC and back again) of the axially configured main piston 14. This is compared to the configuration of the hydraulic device 10 as shown by example in FIG. 13, in which the connecting rods 16 are connected to a pair of pistons 14,20. As discussed above, for variable positioning of the anchor piston 20, each rotation of the cam 55 can result in different stroke lengths (e.g. between TDC and BDC and back again) of the axially configured main piston 14 for different axial positions of the anchor piston 20 in the cylinder bore 24 (e.g. as affected by the volume of hydraulic fluid provided in the chamber 130—see FIG. 13).

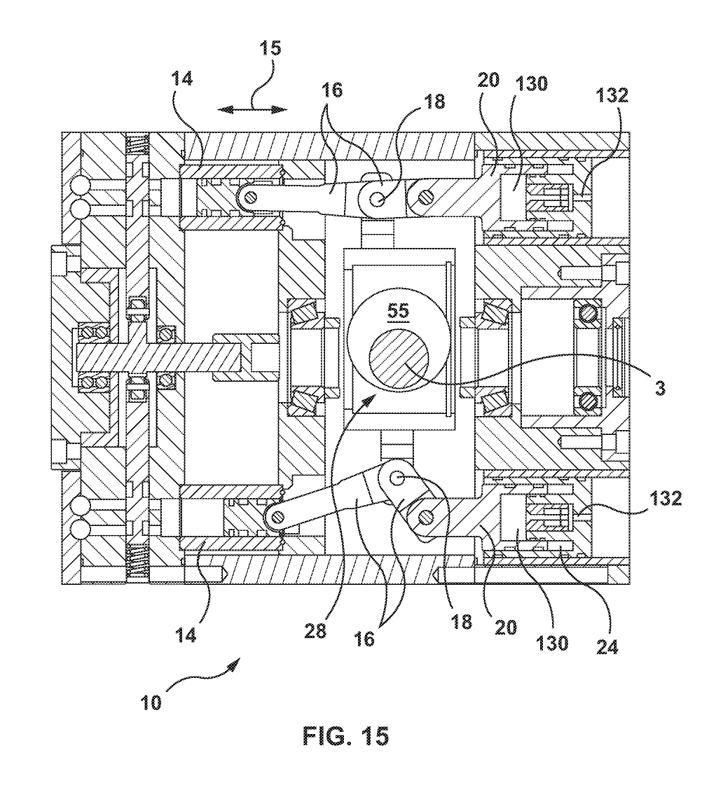

Referring to FIG. 15, shown is a cross sectional view of the hydraulic device 10 having each main piston 14 connected to a corresponding passive or anchor piston 20 via the pair of connecting rods coupled to the off-set cam assembly 28, via the swivel joint 18. As shown, the shaft 30 is oriented transverse (e.g. perpendicular) with the reciprocation 15 of the main pistons 14. In other words, an axis of rotation 3 of the shaft 30 (e.g. also of the cam 55) is transverse (e.g. perpendicular) with the axis of reciprocation 15 for the main pistons 14. Also provided by example, each of the anchor pistons 20 is coupled (e.g. pivotally) on one end to the connecting rod 16 and on the other end to the hydraulic chamber 130 containing an incompressible element (e.g. hydraulic fluid). Pressure/volume of the hydraulic fluid can be adjusted via addition or extraction of the hydraulic fluid from the chamber 130 via the injector 132. Accordingly, the position of the anchor piston 20 can be set via metering the amount of hydraulic fluid set in the chamber 130. As discussed above, positioning of the anchor piston 20 fully towards the end of the cylinder bore 24 nearest to the main piston 14 effectively lengthens the length of stroke available to the main piston 14 during the reciprocation 15. On the contrary, as discussed above, positioning of the anchor piston 20 fully towards the end of the cylinder bore 24 farthest from the main piston 14 effectively shortens the length of stroke available to the main piston 14 during the reciprocation 15. The ability to lengthen or shorten the stroke length of the main piston 14 provides for variable displacement operation of the hydraulic device 10.

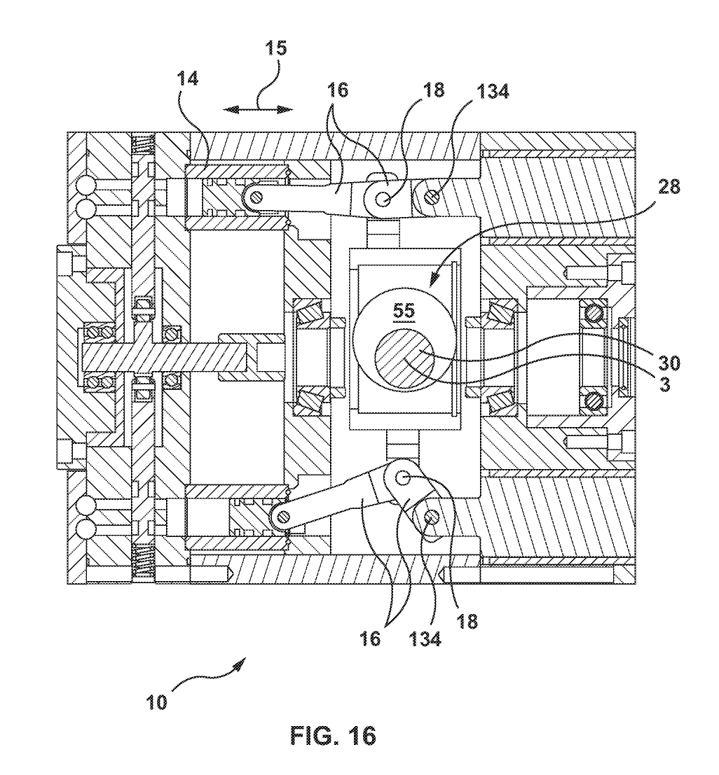

Referring to FIG. 16, shown is an embodiment of the hydraulic device 10 such that the cross sectional view depicts each main piston 14 connected to a corresponding fixed connection point 134 (e.g. pivot point) via the pair of connecting rods 16 coupled to the off-set cam assembly 28, via the swivel joint 18. As shown, the shaft 30 is oriented transverse (e.g. perpendicular) with the reciprocation 15 of the main pistons 14. In other words, an axis of rotation 3 of the shaft 30 (e.g. also of the cam 55) is transverse (e.g. perpendicular) with the axis of reciprocation 15 for the main pistons 14. In this embodiment, the connecting rods 16 are only connected to the single piston 14, rather than a pair of pistons 14,20 as shown in FIG. 15. Accordingly, the single piston 14 (per pair of connecting rods 16) provides for the hydraulic device 10 configured as a fixed displacement axial pump/motor. In other words, the rotation of the off-set cam assembly 28 is directly converted to axial reciprocation 15 of the main piston(s) 14 and vice versa, such that the axial reciprocation 15 is directly coupled to the rotation of the cam 55. For example, each rotation of the cam 55 always results in the same stroke length (e.g. between TDC and BDC and back again) of the axially configured main/only piston 14. This is compared to the configuration of the hydraulic device 10 as shown by example in FIG. 15, in which the connecting rods 16 are connected to the pair of pistons 14,20. As discussed above, variable positioning of the anchor piston 20, each rotation of the cam 55 can result in different stroke lengths (e.g. between TDC and BDC and back again) of the axially configured main piston 14 for different axial positions of the anchor piston 20 in the cylinder bore 24 (e.g. as affected by the volume of hydraulic fluid provided in the chamber 130—see FIG. 13). The inability to lengthen or shorten the stroke length of the main piston 14 provides for a fixed displacement operation of the hydraulic device 10.

I claim:

1. An axial reciprocation device having a main piston and an anchor piston coupled to one another via a swivel joint interconnecting a pair of connecting rods, the main piston positioned in a main cylinder bore and the anchor piston positioned in an anchor piston bore of a housing, such that the main piston is configured for axial reciprocation in the main cylinder bore; wherein variable positioning of the anchor piston along the anchor piston bore results in variable displacement of the main piston of hydraulic fluid with respect to an inlet/outlet port of the housing.

2. The axial reciprocation device of claim 1 further comprising an offset cam assembly for reciprocating the swivel joint transverse to a direction of the axial reciprocation.

3. An axial reciprocation device having a piston coupled to a housing via a swivel joint interconnecting a pair of connecting rods, the piston positioned in a cylinder bore, such that the piston is configured for axial reciprocation in the cylinder bore; wherein in the axial reciprocation results in fixed displacement of the main piston of hydraulic fluid with respect to an inlet/outlet port of the housing.

4. The reciprocation device of claim 3 further comprising an offset cam assembly for reciprocating the swivel joint transverse to a direction of the axial reciprocation.
